(19) United States
(12) Patent Application Publication
(10) Pub. No.: US 2023/0354424 A1
(43) Pub. Date: Nov. 2, 2023

(54) DIRECT LINK RESOURCE RELEASING MECHANISM IN A MULTI-USER TXOP

(71) Applicant: CANON KABUSHIKI KAISHA, Tokyo (JP)

(72) Inventors: Patrice NEZOU, LIFFRE (FR); Romain GUIGNARD, RENNES (FR); Pascal VIGER, JANZE (FR); Stéphane BARON, LERHEU (FR)

(21) Appl. No.: 18/004,865

(22) PCT Filed: Jul. 16, 2021
(86) PCT No.: PCT/EP2021/070018

§ 371 Date: Jan. 9, 2023

(30) Foreign Application Priority Data
Jul. 17, 2020 (GB) 2011071.4

(51) Int. Cl. H04W 74/08; H04W 76/30

(52) U.S. Cl. CPC H04W 74/0816; H04W 76/30

(57) ABSTRACT

An access point, AP, is granted a transmission opportunity to schedule multi user transmissions with non-AP stations. The AP can provide resource units to peer stations for direct link transmission, within the TxOP. The DiL resource units are allocated for a duration. However, the duration may not match the peer needs and be too long. It results that bandwidth is lost. To give back the resource unit to the AP, a peer station sends, upon finishing the DiL transmission, a resource releasing frame, such as a QoS Null frame, to the AP over the allocated DiL resource unit. The AP may then reuse the time saved to offer more transmission time to other stations within the TxOP.

### FIELD OF THE INVENTION

The present invention generally relates to wireless communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE®) provides a great number of mechanisms for wireless communications between stations.

In order to address the issue of increasing bandwidth and decreasing latency requirements that are demanded for wireless communications systems in high-density environments, multi-user (MU) schemes are being developed to allow a single access point (AP) to schedule MU transmissions, i.e. multiple simultaneous transmissions to or from non-AP stations, in the wireless network. For example, one of such MU schemes has been adopted by the IEEE in the 802.11ax standard, draft version 6.0 (D6.0) of November 2019.

The adopted 802.11ax MU transmission scheme is not adapted to bandwidth-demanding communication services, e.g. video-based services such as gaming, virtual reality, streaming applications. This is because all the communications go through the AP, thereby doubling the air time for transmission but also the number of medium accesses (and thus of medium access time).

The Single User (SU) scheme of 802.11 network protocol allows a direct link (DiL, also called peer-to-peer (P2P) transmission) to be performed wherein the data (MAC) frames are addressed using the 48-bit IEEE MAC address of the destination station.

However, SU and MU schemes directly compete one against the other to gain access to the wireless medium (by the AP for MU schemes, by a non-AP station for the SU scheme). In high density environments, this competition generates a large amount of undesirable collisions, thereby degrading latency and overall useful data throughput.

### SUMMARY OF INVENTION

To overcome some of the foregoing concerns, the inventors contemplates integrating DiL/P2P communications under the global policy of the AP's scheduling during a granted transmission opportunity, TxOP.

In this context, the invention first provides a communication method in a wireless network, comprising at a peer station:

receiving, from an access point, AP, a triggering frame providing the peer station with a resource unit for direct link, DiL, transmission during a transmission opportunity, TxOP, granted to the AP,

performing DiL transmission with another peer station over the provided resource unit, and

upon finishing the DiL transmission, sending a resource releasing frame to the AP over the provided resource unit.

The invention also provides a communication method in a wireless network, comprising at an access point, AP, during a granted transmission opportunity, TxOP:

transmitting a triggering frame providing a resource unit for direct link, DiL, transmission to peer stations,

receiving, from one of the peer stations, a resource releasing frame over the provided resource unit.

Therefore, responsive to the resource releasing frame, the AP resumes transmission over the resource unit, for instance by performing a MU DL transmission or triggering a MU UL transmission.

In the proposed schemes, the AP acts as a central point for scheduling resource units at the BSS level within the granted TxOP. Resource units may be used for downlink (i.e. from the AP), uplink (i.e. to the AP) and DiL transmissions. A resource unit may thus be provided for DiL to peer stations.

One peer station manages the DiL resource unit, for example by subleasing or time sharing the resource with the corresponding peer station (with which the managing peer station has a direct link session established). This is efficient because the managing peer station usually has knowledge of the communication needs of the other peer station.

This two-level control of resource units results into an efficient and simple management of the resources, in particular for direct link communications.

Furthermore, the resource releasing frame is a dedicated message ending the DiL transmission, thus releasing the resource unit used for DiL transmission. The AP recovers usage of this resource before the initial end of the resource unit allocation and can use it immediately (a SIFS after), thus avoiding unnecessary padding to maintain signal over the resource unit during all the resource unit allocation. Consequently, bandwidth usage of the wireless network is improved.

Correlatively, the invention also provides a wireless communication device comprising at least one microprocessor configured for carrying out the steps of any of the above methods.

Optional features of embodiments of the invention are defined in the appended claims. Some of these features are explained here below with reference to a method, while they can be transposed into device features.

In some embodiments, the resource unit is provided for a predefined duration, and the resource releasing frame is sent (peer station) or received (AP) before the end or expiry of the predefined duration. Preferably, it is sent a SIFS after the last packet of the DiL transmission. The DiL transmission comprises all the packets exchanged between the peer stations, including data but also acknowledgment thereof. The resource releasing frame may consequently be sent a SIFS after a data packet or a SIFS after an acknowledgment, if any.

According to an optional feature, the method at the AP further comprises setting a network allocation vector, NAV, to defer a medium access by the AP to the end of the predefined duration.

According to another optional feature, the method, at the peer station, further comprises sending, responsive to the reception of the triggering frame, a resource acknowledging frame to the AP before starting performing DiL transmission with the other peer station. Correlatively, at the AP, the method further comprises, receiving, in response to the reception of the triggering frame, a resource acknowledging frame from the peer station. In that case, the AP may set its NAV responsive to receiving the resource acknowledging frame. This advantageously provides better control on the allocated resource units.

To be noted that a variant to the use of the resource acknowledging frame may consist in detected energy on the allocated DiL resource unit.

In some embodiments, the method further comprises receiving, from the AP or transmitting during the granted TxOP, one or more triggering frames triggering multi-user, MU, transmissions. This defines a cascading scheme managed by the AP for MU transmissions wherein the benefits of the present invention to incorporate DiL opportunities are substantial.

In some embodiments, the resource releasing frame is a Single User, SU, data frame. SU frame format is defined in 802.11.

In particular embodiments, the resource releasing frame is an 802.11 QoS Null frame. This advantageously limits the bandwidth used to end the DiL transmission and release the DiL resource unit.

Alternatively, the resource releasing frame is an enhanced 802.11 QoS Null frame including a Buffer Status Report, BSR. This approach advantageously provides useful information to the AP with a view of scheduling new transmissions for the peer station sending the resource releasing frame.

In particular, the BSR may include DiL needs for the peer station. Of course, BSR may also comprise peer station's needs regarding UL transmissions.

In particular embodiments, the resource releasing frame is a unicast 802.11 CF-End frame addressed to the AP. This advantageously limits the bandwidth used. Furthermore, using a unicast addressing (rather than a broadcast addressing as required for CF-End in known techniques) ensures only the AP reset its NAV.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical 802.11 network environment in which embodiments of the invention may be implemented;

FIG. 2 illustrates an exemplary scenario of use of a TxOP granted to an AP;

FIG. 3 illustrates the exemplary scenario of FIG. 2 in which embodiments of the invention are implemented;

FIG. 3a illustrates a variant to FIG. 3;

FIG. 4 illustrates, using a flowchart, general steps at the AP for implementations of the present invention;

FIGS. 5a and 5b illustrate, using flowcharts, general steps at the peer stations of a DiL transmission;

FIG. 6a shows a schematic representation a communication device in accordance with embodiments of the present invention; and

FIG. 6b shows a schematic representation of a wireless communication device in accordance with embodiments of the present invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

An AP may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

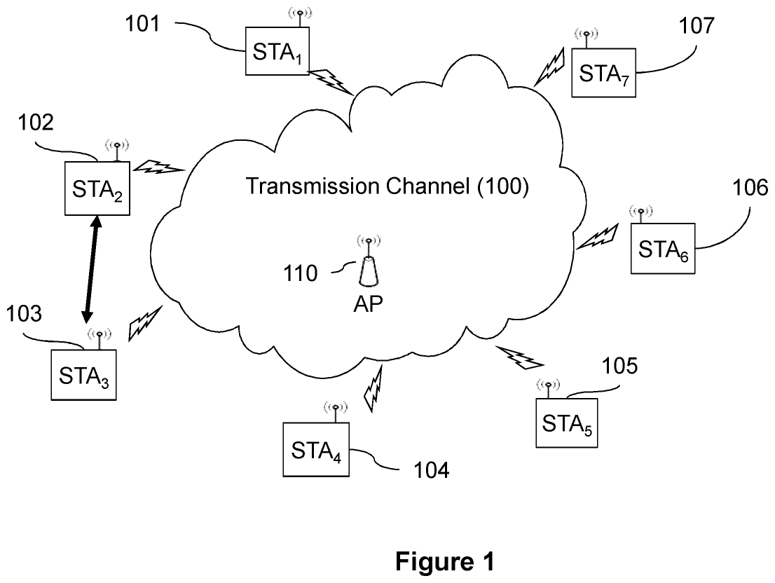

FIG. 1 illustrates an exemplary communication system in which several communication stations 101-107, 110 exchange data frames over a radio transmission channel 100 of a wireless local area network (WLAN), under the management of a central station, or access point (AP) 110, also seen as a station of the network. The radio transmission channel 100 is defined by an operating frequency band constituted by a single channel or a plurality of channels forming a composite channel. The AP 110 and the associated non-AP stations 101-107 may represent a basic service set (BSS) or an extended service set (ESS).

Two non-AP stations 102, 103 may also communicate directly via a direct wireless link (DiL for direct link) regardless of whether both non-AP stations belong to the same BSS or ESS. In a variant, direct communications between non-AP stations can be implemented without the use of the access point (known as an Ad-hoc mode). For instance, WiFi-Direct standard allows devices to communicate directly over the 802.11 wireless medium without the need for any AP.

Exemplary situation of direct communications, corresponding to an increasing trend nowadays, is the presence of peer-to-peer (P2P) transmissions between non-AP stations having the same primary channel, be them from the same BSS or ESS, or not. Technologies that support P2P transmissions between non-AP STAs not associated with the same BSS/ESS or no BSS include for example WiFi-Miracast® and Wireless Display scenario, in addition to WiFi-Direct. Other technologies that support P2P transmissions within a BSS/ESS include Direct Link Setup (DLS) and Tunneled Direct Link Setup (TDLS). Even if P2P flows are usually not numerous, the amount of data per flow tends to be important, typically low-compressed video, from 1080p60 up to 8K UHD resolutions.

Each non-AP stations 101-107 registers to the AP 110 during an association procedure where the AP assigns a specific Association IDentifier (AID) to the requesting non-AP station. For example, the AID is a 16-bit value uniquely identifying the non-AP station. The stations 101-107, 110 may compete one against another using EDCA (Enhanced Distributed Channel Access) contention, to access the wireless medium 100 in order to be granted a transmission opportunity (TXOP) and then transmit (single-user, SU) data frames. The stations may also use a multi-user (MU) scheme in which a single station, usually the AP 110, is allowed to schedule a MU transmission, i.e. multiple simultaneous transmissions to or from other stations, during a TXOP granted in the wireless network. One implementation of such a MU scheme has been for example adopted in IEEE 802.11ax amendment standard, as the Multi-User Uplink and Downlink OFDMA (MU UL and DL OFDMA) procedures. Thanks to the MU feature, a non-AP station has the opportunity to gain access to the wireless medium via two access schemes: the MU scheme and the conventional Enhanced Distributed Channel Access—EDCA (Single User) scheme.

During the MU DL transmission on the granted communication channel, the AP performs multiple simultaneous elementary transmissions, over so-called resource units (RUs), to various non-AP stations. As an example, the resource units split the communication channel of the wireless network in the frequency domain, based for instance on Orthogonal Frequency Division Multiple Access (OFDMA) technique. The assignment of the RUs to the non-AP stations is signaled at the beginning of the MU Downlink frame, by providing an association identifier (AID) of a non-AP station (individually obtained by each station during its association procedure with the AP) for each RU defined in the transmission opportunity.

During the MU UL transmission, various non-AP stations can simultaneously transmit data to the AP over the resource units forming the communication channel. To control the MU UL transmission by the non-AP stations, the AP previously sends a control frame, known as a Trigger Frame (TF). The Trigger Frame allocates the resource units to the non-AP stations of the same BSS, using 16-bit Association IDentifiers (AIDs) assigned to them upon registration to the AP and/or using reserved AIDs designating a group of non-AP stations. The TF also defines the start of the MU UL transmission by the non-AP stations as well as the length thereof.

A variant to trigger UL transmission relies on the use of a TRS (standing for Trigger Response Scheduling) control subfield. Such TRS control subfield is added to the DL data frames the AP sends to non-AP stations over resource units (MU DL transmission) in order to provide resource unit allocations to the addressee non-AP stations for a subsequent MU UL transmission. Each TRS subfield only allocates a single resource unit (and provides transmission parameters too) for the addressee non-AP station that receives the DL data frame.

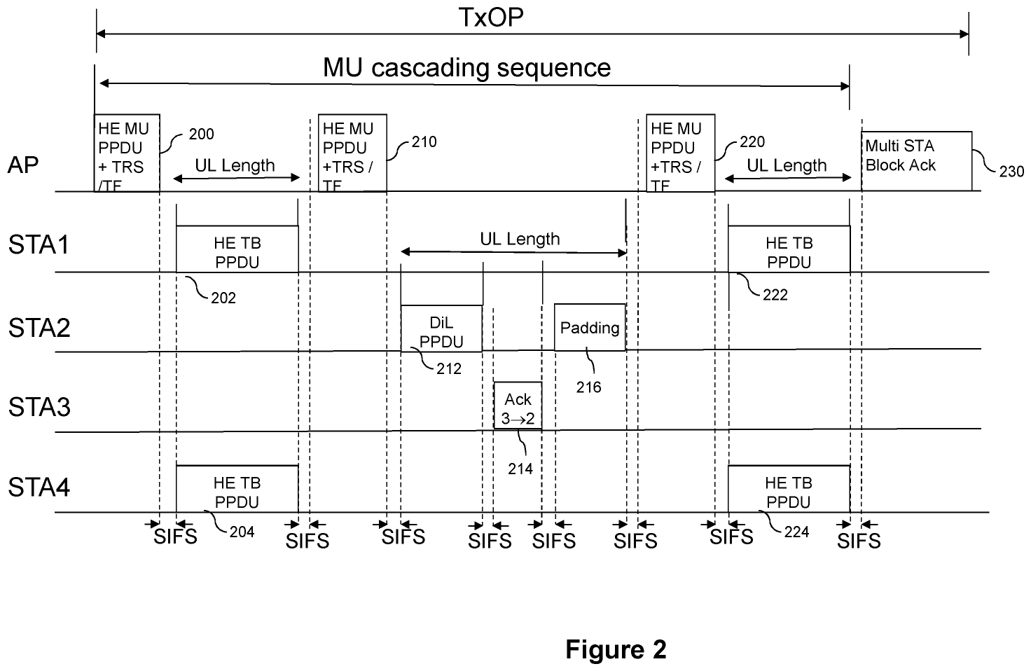

FIG. 2 illustrates an exemplary scenario of use of a TxOP granted to the AP. In this scenario, the AP provides a cascading sequence of various transmissions, including Uplink (UL), Downlink (DL) and/or DiL transmissions.

The MU cascading mechanism has been introduced in the 802.11ax amendment, to allow alternating between Uplink (UL) and Downlink (DL) data transmission quickly. The principle, is to alternate MU DL transmissions and MU UL transmissions during a single TXOP won by the AP.

This mechanism provides a low latency transmission for interactive applications, allows a better flexibility to the AP for the scheduling of the non-AP stations, and is also used in the scope of the TWT (Target Wake up time) to schedule in time different non-AP stations in power saving mode (typically sleeping) that negotiated a power saving contract with the AP.

In all those cases, the AP initiates the cascading sequence by sending one or more triggering frames 200 (MU PPDUs). The triggering frame 200 may be a mere 802.11 trigger frame or may be a DL data frame (MSDU) including a Trigger Response Scheduling (TRS) control subfield (in which case several triggering frames are sent to respective addressee non-AP stations). These frames provide an allocation of one or more resource units forming the communication channel, to the non-AP stations.

The trigger frame is broadcasted to all the non-AP stations, while each DL data frame with TRS is sent to a specific addressee non-AP station.

Upon receiving the triggering frame 200, each addressee non-AP station decodes the received MSDU and the included TRS subfield to know the allocation of a resource unit.

Similarly, in case of a trigger frame, each non-AP station determines whether its AID is specified in one of the User Info fields describing the allocation of the resource units forming the communication channel. In the affirmative (AID12 subfield of the User Info field equals to the 12 LSBs of its AID or takes a reserved value announcing a random resource unit), the non-AP station decodes the associated User Info field.

Thanks to the information provided in the User Info fields or the TRS control subfield, each non-AP station knows whether it has a resource unit assigned to it or not. In the affirmative, the triggering frame 200 also provides associated transmission parameters to use such as MCS (Modulation and Coding Scheme), Target RSSI, etc., as well as the length (duration) of the RU allocation (specified in a so-called UL LENGTH subfield for a trigger frame or indirectly specified in the UL Data Symbol subfield for the TRS control field).

In the present scenario, STA1 and STA4 are each allocated a resource unit (RU) for MU UL transmission.

Next, these non-AP stations create a MU UL data frame (HE TB PPDU) to be transmitted on the allocated RU to the AP.

To do so, the non-AP station first determines the transmission time (TxTime) that is granted by the AP, based on the indication provided in the triggering frame 200: UL LENGTH subfield for the trigger frame, in which case TxTime=(UL LENGTH)/3*4+24, or UL Data Symbol subfield (indicating the number of OFDM symbol of the Data portion of the HE TB PPDU to be transmitted in response) for TRS, in which case the combination of this information with the UL HE MCS subfield of the TRS control field provides the TxTime (since the HE TB PPDU preamble size is known). The non-AP station then determines, based on the MCS indicated by the AP, the amount of data that can be transmitted within the resource unit allocated.

Based on this information, it creates the MSDU packet (that can contain acknowledgements or new data) and then encapsulates it into a HE TB PPDU. The non-AP station then transmits it over the allocated resource unit a Short Inter Frame Space (SIFS) duration after the end of the reception of the triggering frame 200.

In the scenario shown, STA1 transmits HE TB PPDU 202 to the AP while STA4 transmits HE TB PPDU 204 to the AP.

Immediately after the transmission of the triggering frame 200, the AP listens to the medium, waiting for receiving the HE TB PPDUs 202/204. During the transmission period of the received HE TB PPDUs 202/204, the AP decodes the PPDUs (that are all intended to it).

A SIFS duration after the end of the transmission, the AP is allowed to take the medium again, and to use it to continue the cascading sequence of DL and UL transmissions until then end of the TxOP.

In the scenario shown, two non-AP stations (STA2 and STA3) have established a direct link (DiL) session prior to the MU cascading sequence. This is not the object of the present document to describe the way the two peer stations establish such direct link session. The stations can for example follow the procedure described in the 802.11 specification. Following the transmission of HE TB PPDUs 202/204, the AP wishes to offer a DiL transmission opportunity to the peer stations.

To do so, the AP creates a second triggering frame 210 indicating STA2 as the recipient of a DiL resource unit spanning the whole operating band. This means that no other transmission can occur in parallel of the STA2 transmission. The triggering frame 210 may be an 802.11 trigger frame or a MU DL PPDU addressed to STA2 and including a TRS control subfield.

In the case of a trigger frame, a single User Info field is provided assigning the sole RU (using all the operating band) to STA2. Furthermore, the allocated RU is indicated, in the triggering frame 210, as being dedicated for direct link transmission. Various signalling may be contemplated to provide this indication: using 1 bit (reserved bit in the current version of 802.11ax) of the User Info field; setting the AID12 field of the User Info field to a specific value indicating an RU for direct link while the AID of the peer station (STA2) is encoded in a specific format in the Trigger Dependent Info field of the User Info field; or using any meaningless (in the case of DiL) subfield of the User Info field itself, such as bits B12 to B31 to indicate the AID of the source peer station, the AID of the destination peer station, or an AID or identifier specific to the DiL session between those two peer stations. Any other signalling can be used in the context of the invention, provided the RU is marked as dedicated for DiL.

Equivalent signalling may be provided in the case of the TRS control field.

Next, the AP transmits the triggering frame 210 providing the peer stations (STA2 and STA3) with the DiL resource unit.

Because, it allocates an RU for Direct Link transmission, i.e. in which it is not involved, the AP set its Network Allocation Vector (NAV) to the effect of deferring its next medium access until the end of the DiL transmission, i.e. the end of the TxTime of the allocated RU. This aims at avoiding any collision with a DiL transmission that the AP could not detect (e.g. when STA3 is out of the AP's receiving range while being in STA2's range).

Upon reception of the triggering frame 210, peer STA2 determines from the received frame that it is allocated a DiL resource unit. STA2 determines the TxTime duration based on the parameter values received in the triggering fame 210 (e.g the UL Length field from the trigger frame, or the UL Data Symbol parameters and UL HE MCS from the TRS control field).

As the DiL duration is to be shared with peer STA3, STA2 determines a new transmission time TxTime2 corresponding to the time it has to transmit its own DiL data. In the scenario shown (with a transmission for each of STA2 and STA3), this is done by subtracting to the determined TxTime duration, 2 SIFS durations and the duration required by the other peer station, STA3, to send its data or an acknowledgment (as in the proposed scenario).

Once TxTime2 is known, STA2 determines the optimum MCS value to transmit the data based on the SNR measured for instance during the last DiL transmission to STA3. Based on these MCS and TxTime2 values, STA2 can determine the amount of DiL data it can send to STA3. Consequently, STA2 creates DiL PPDU 212 and transmits it over the allocated DiL RU. DiL PPDUs preferably follow a Single User frame format.

STA3 receives DiL PPDU 212 on the DiL RU, decodes it, creates an acknowledgment packet 214, and transmits it to STA2, a SIFS duration after the end of the DiL PPDU reception time, over the same DiL RU.

If the amount of DiL data the peer stations exchange is not enough to use the allocated DiL RU during the whole TxTime, the peer station managing the allocated RU (here STA2) can transmit padding packets 216 over the RU until the end of the RU allocation in order to keep activity (to avoid legacy stations see the channel as idle and access it).

A SIFS duration after the end of the DiL RU allocation, the AP is allowed to take the medium again, and to use it to continue the cascading sequence of DL and UL transmissions until then end of the TxOP. In the scenario shown, a new MU UL transmission is triggered. Triggering frame 220 and resulting HE TB PPDUs 222, 224 sent by non-AP stations may be managed in a similar fashion as for triggering frame 200 and resulting HE TB PPDUs 202, 204.

At the end of the TxOP, the AP may send a Multi STA block ACK packet 230 that acknowledges all the HE TB PPDUs received during the cascading sequence.

Although the scenario contemplates a cascading of two MU UL transmissions with a DiL transmission between them, other configurations may be envisioned, for instance starting the cascading with a DiL transmission, having several MU UL transmissions or several DiL transmissions on a row, providing MU DL transmissions between MU UL transmissions and/or DiL transmissions.

As readily apparent from the proposed scenario, the AP can badly evaluate the needs of the peer stations and then provides too large DiL resource units, resulting in unnecessary padding 216 to keep activity on the allocated resource unit until the end of the allocated DiL time.

To overcome this deficiency, the present invention proposes for the peer station, here STA2, upon finishing the DiL transmission with STA3, to send a resource releasing frame to the AP over the provided resource unit. In the scenario shown, the DiL transmission ends when STA3 finishes sending the acknowledgment frame 214. As a consequence of this transmission, the AP receives, from the peer station, the resource releasing frame over the provided resource unit. And, responsive to the resource releasing frame, the AP can resume transmission over the resource unit, i.e. it is allowed to take the medium again and to use it to continue the cascading sequence of DL and UL transmissions until then end of the TxOP. Padding is therefore avoided, saving time for other DL, UL and/or DiL transmissions during the TxOP.

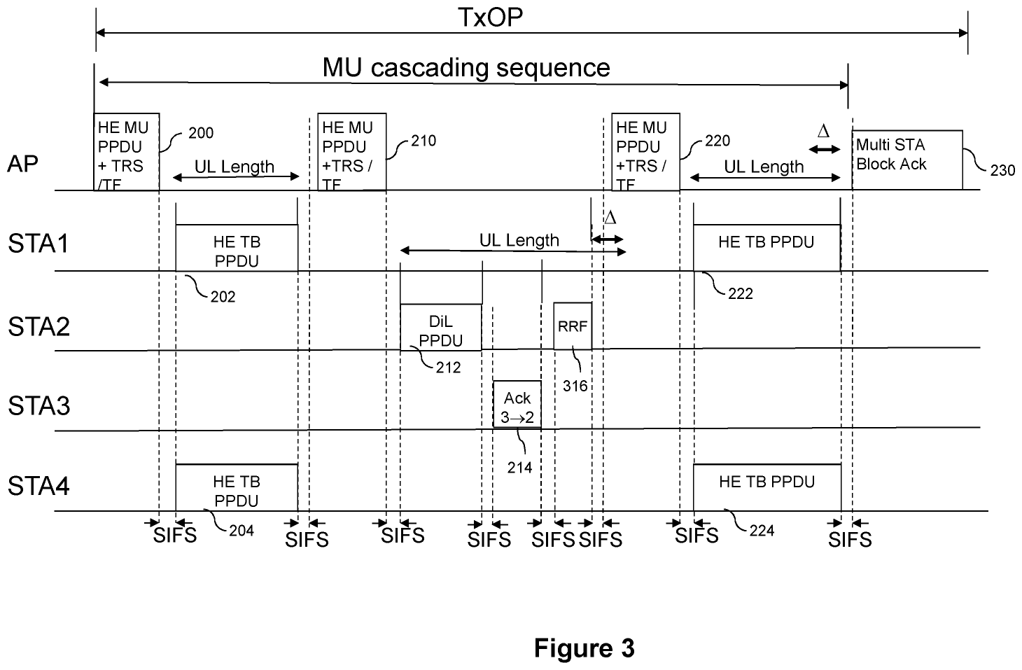

FIG. 3 illustrates the same exemplary scenario implementing the invention according to embodiments.

The beginning of the scenario remains unchanged although it is merely illustrative (other type of transmission may occur): MU UL transmission from STA1 and STA4 followed by the DiL transmission of DiL PPDU 212 and acknowledgment 214.

Upon receiving the acknowledgment packet 214, peer STA2 creates the resource releasing frame (RRF) 316, namely a dedicated SU PPDU ending the DiL transmission and enabling the AP to resume its NAV.

Advantageously, this resource releasing frame 316 is substantially shorter than the amount of padding (FIG. 2) required to keep activity on the communication channel. It results that the duration of the DiL resource allocation is shortened (by the A time), thereby no losing bandwidth even if the AP has set its NAV with a long duration; and this time may be allocated to a subsequent MU transmission (here the subsequent MU UL transmission) during the TxOP. In the example of FIG. 3, STA1 and STA4 are thus offered a larger UL length (by A) for their HE TB PPUDs 222, 224.

In a first embodiment, RRF 316 is a (802.11) QoS Null frame addressed to the AP. This is advantageously a very short frame, thereby saving bandwidth.

In a second embodiment, RRF 316 is an enhanced (802.11) QoS Null frame including a Buffer Status Report (BSR).

The BSR is used by the emitting peer station (here STA2) to provide the AP with its transmission needs. It may be related to the DiL transmission needs of the current DiL session and/or all the other future data transmissions (other DiL transmissions in other DiL sessions, UL transmissions, etc.). In practice, the BSR may be inserted within a so-called A-control subfield (standing for aggregated control) of the HE subfield of the QoS Null Frame.

When the AP receives this BSR sent by STA2, it is able to schedule additional resource units for STA2 (either as a peer station or as a MU UL non-AP station).

In a third embodiment, RRF 316 is a CF-End frame as described in the IEEE802.11-2016 specification—section 9.3.1.7., but addressed to the AP (CF-End is used as a unicast frame). This sharply contrasts with the specification where the CF-End frame is broadcast in order to advise all the stations (AP and no-AP) that the TxOP ends. By addressing the CF-End only to the AP, the third embodiment ensures that only the AP becomes aware that the DiL resource is released. This is for the AP to be the first to recover control over the communication channel (because its granted TxOP is still continuing), by resuming its NAV.

The scenario shown in the Figures is only for illustrative purposes. Plenty of scenarios may be contemplated as long as a resource unit is allocated for DiL during a subpart of a TxOP granted to the AP.

FIG. 3a illustrates a slight variant to FIG. 3 wherein the peer station further sends, responsive to the reception of the triggering frame 210, a resource acknowledging frame 311 to the AP before starting performing DiL transmission with the other peer station. The AP thus receives this message and can set its NAV accordingly.

The resource acknowledgment frame, RAF 311, is formatted as a HE TB PPDU. Its multiple roles include announcing the start of the DiL transmission, acknowledging the reception of the TF sent by the AP and enabling the AP to set its NAV.

The payload of the RAF 311 may be any of the payloads described for the RRF 316 (QoS Null frame, QoS Null frame+BSR, CF-END frame), formatted to a HE TB PPDU. In the 802.11ax standard, draft version 6.0 (D6.0) of November 2019, the good reception of a Trigger frame is validated by the AP by the reception of an HE TB PPDU. Therefore, the RAF 311 advantageously ensures compliancy with the 802.11ax standard.

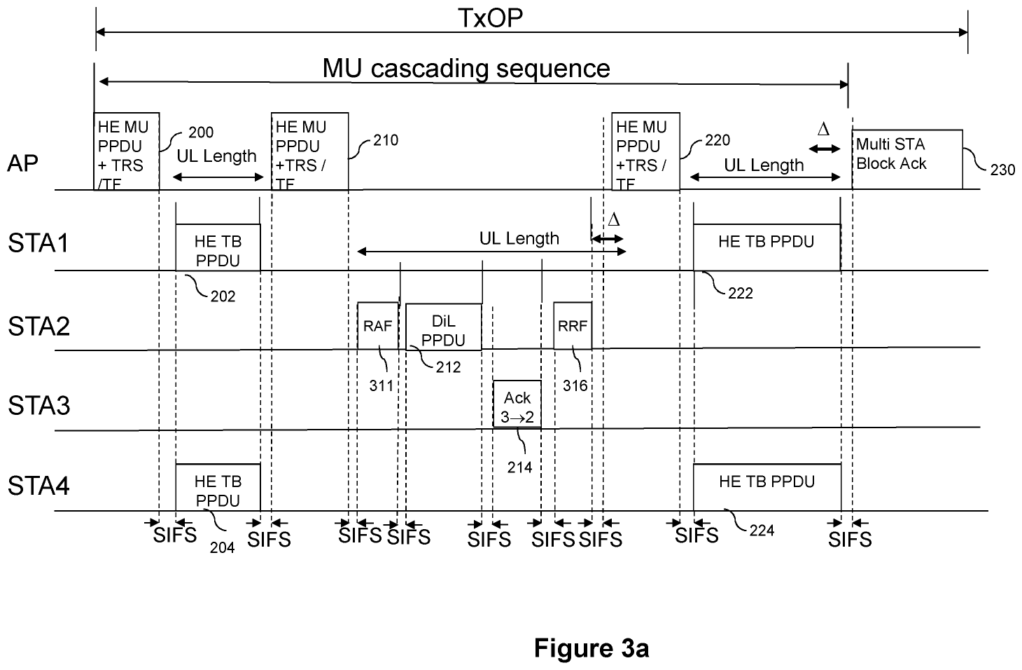

FIG. 4 illustrates, using a flowchart, general steps at the AP for implementations of the present invention. It only describes the AP's operations during a DiL phase offered within the granted TxOP (operations to manage UL and DL transmissions are not shown).

At step 400, the AP determines the duration (UL LENGTH or UL Data Symbol with associated MCS) of the next cascading phase, here a DiL phase. This may be based on the DiL needs declared by the peer stations (STA2, STA3) to the AP. The AP next generates triggering frame 210 (trigger frame or MU PPDU with TRS) allocating at least one RU for DiL transmission for the determined duration.

The DiL RU may encompass the whole operating band. Alternatively, it is a multiple of 20 MHz (aligned on the 802.11 channels) but thinner than the operating band. In that case, it is preferable than the frequency band of the DiL RU includes the primary channel to allow an easy detection of the packet by legacy peer stations.

In some embodiments, the triggering frame 210 comprises an additional indication that one or more other DiL resource units will be allocated to the same peers during the current TxOP (i.e. in a subsequent phase of the cascading sequence).

At step 410, the AP transmits the generated triggering frame 210 on the current operating band.

At step 420, the AP sets its NAV for the duration determined at step 400. This step is optional. Furthermore, step 420 may be responsive to receiving a resource acknowledging frame RAF 311 from a peer station (test 415).

Steps 430 and 440 track the end of the allocation of the DiL RU, either due to the expiry of the NAV or due to the reception of the RRF 216. Although one order of the two tests is shown in the Figure, a reverse order is possible.

When one of the two tests is positive, meaning the AP is allowed to take the medium again, it initiates the next phase of the cascading sequence (step 450) for new data transmission within the granted TxOP.

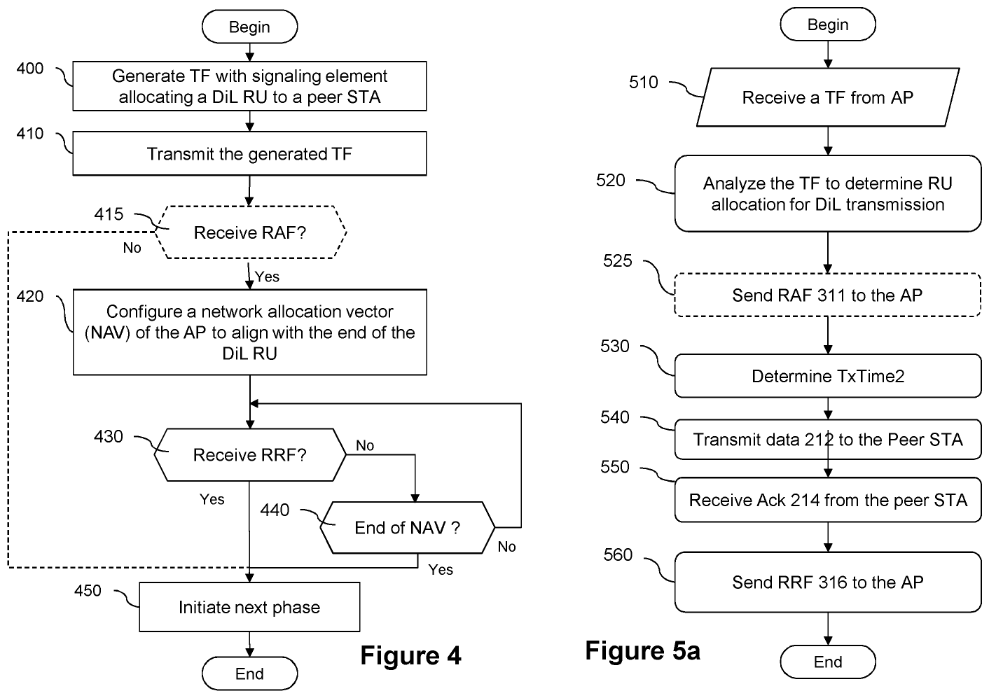

FIGS. 5a and 5b illustrate, using flowcharts, general steps at the peer stations of a DiL transmission.

FIG. 5a illustrates the operations at the peer station responsible of the DiL RU allocated by the AP, e.g. STA2 in FIG. 3, when it emits DiL data.

At step 510, the peer station receives triggering frame 210 that contains for instance a trigger frame or a QoS Data MSDU with a TRS control field.

At step 520, the peer station decodes the content of the received triggering frame to determine whether a DiL RU is allocated to it by the AP and, in the affirmative which RU. The peer station also retrieves the associated transmission parameters and DiL allocation duration.

Optional step 525 consists in sending a resource acknowledging frame RAF 311 to the AP.

At step 530, the peer station determines the duration TxTime2 for the DiL PPDU to transmit. As mentioned earlier, this duration can be computed using the UL Length value, the MCS chosen and the DiL needs of the other peer station.

At Step 540, using TxTime2, the peer station prepares a PPDU 212 for direct link transmission including the ACK policy for this transmission, and transmits it over the allocated DiL RU.

Optional step 550 wait and decodes the immediate acknowledgement 214 sent by the destination peer of the DiL transmission (here STA3).

At step 560, the DiL transmission is over. The peer station sends RRF 316 to the AP as a dedicated SU PPDU. This allows the AP to resume its NAV (if set) and to recover the medium access that has been subleased to the peer stations.

FIG. 5b illustrates the operations at the other peer station, e.g. STA3 in FIG. 3. At step 580, the peer station receives a DiL PPDU 212 from the originator peer (STA2) in a SU PPDU format on a multiple of 20 Mz band (potentially all the operating band).

In some embodiments, the peer station may be prepared to receive the DiL PPDU 212 by previously decoding the triggering frame 210. In a variant, the peer station only senses the medium on the operating band and detects the DiL PPDU 212 addressed to it when arriving. Optional step 590 determines whether an immediate acknowledgement is required.

In the affirmative, a PPDU 214 containing the acknowledgment of the successfully received packet is prepared and sent back (a SIFS after the end of the received DiL PPDU 212) to the originator peer, over the same DiL RU.

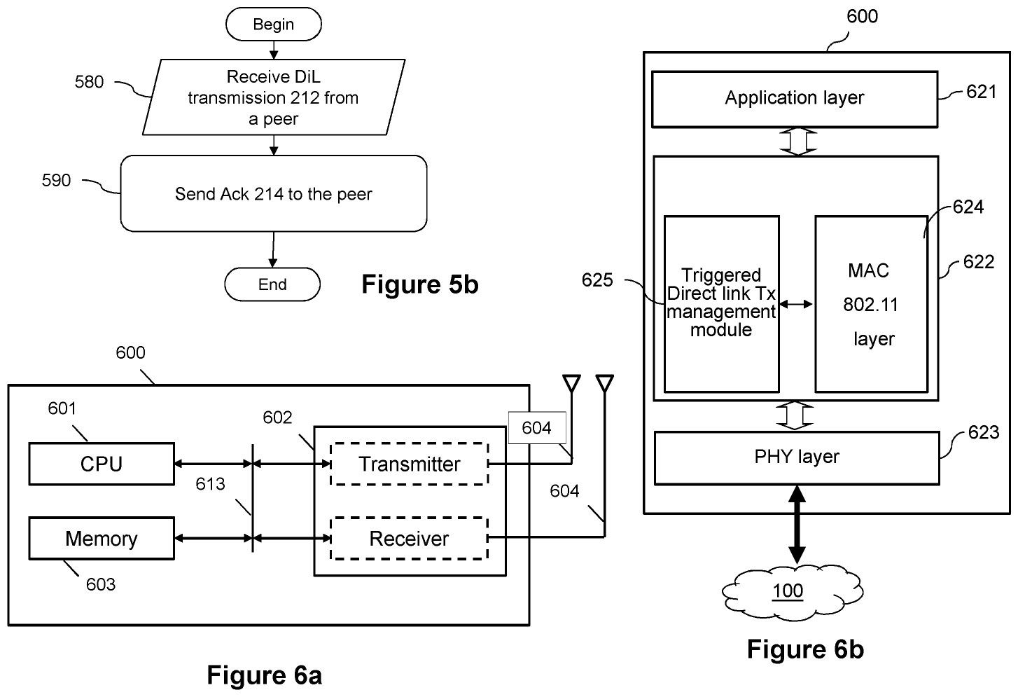

FIG. 6a schematically illustrates a communication device 600, either a non-AP station 101-107 or the access point 110, of the radio network 100, configured to implement at least one embodiment of the present invention. The communication device 600 may preferably be a device such as a micro-computer, a workstation or a light portable device. The communication device 600 comprises a communication bus 613 to which there are preferably connected:

a central processing unit 601, such as a processor, denoted CPU;

a memory 603 for storing an executable code of methods or steps of the methods according to embodiments of the invention as well as the registers adapted to record variables and parameters necessary for implementing the methods; and

at least one communication interface 602 connected to a wireless communication network, for example a communication network according to one of the IEEE 802.11 family of standards, via transmitting and receiving antennas 604.

Preferably the communication bus provides communication and interoperability between the various elements included in the communication device 600 or connected to it. The representation of the bus is not limiting and in particular the central processing unit is operable to communicate instructions to any element of the communication device 600 directly or by means of another element of the communication device 600.

The executable code may be stored in a memory that may either be read only, a hard disk or on a removable digital medium such as for example a disk. According to an optional variant, the executable code of the programs can be received by means of the communication network, via the interface 602, in order to be stored in the memory of the communication device 600 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 6b is a block diagram schematically illustrating the architecture of the communication device 600, either the AP 110 or one of stations 101-107, adapted to carry out, at least partially, the invention. As illustrated, device 600 comprises a physical (PHY) layer block 623, a MAC layer block 622, and an application layer block 621.

The PHY layer block 623 (here an 802.11 standardized PHY layer) has the task of formatting, modulating on or demodulating from any 20 MHz channel or the composite channel, and thus sending or receiving frames over the radio medium used 100, such as 802.11 frames, for instance medium access trigger frames TF 210 to reserve a transmission slot, MAC data and management frames based on a 20 MHz width to interact with legacy 802.11 stations, as well as of MAC data frames of OFDMA type having smaller width than 20 MHz legacy (typically 2 or 5 MHz) to/from that radio medium.

The MAC layer block or controller 622 preferably comprises an 802.11 MAC layer 624 implementing conventional 802.11ax MAC operations, and additional block 625 for carrying out, at least partially, the invention. The MAC layer block 622 may optionally be implemented in software, which software is loaded into RAM 603 and executed by CPU 601.

Preferably, the additional block 625, referred to as Triggered Direct Link Tx management module, implements the part of embodiments of the invention (either from station perspective or from AP perspective). This block performs the operations of FIGS. 4, 5a and/or 5b, depending on the role of the communication device 600.

802.11 MAC layer 624, Triggered Direct Link Tx management module 625 interact one with the other in order to process accurately communications over OFDMA RU addressed to multiple stations according to embodiments of the invention.

On top of the Figure, application layer block 621 runs an application that generates and receives data packets, for example data packets such as a video stream. Application layer block 621 represents all the stack layers above MAC layer according to ISO standardization.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular, the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network, comprising at a peer station:
receiving, from an access point, AP, a triggering frame providing the peer station with a resource unit for direct transmission during a transmission opportunity, TxOP, granted to the AP,
performing the direct transmission with another peer station over the provided resource unit, and
upon finishing the direct transmission, sending a resource releasing frame for releasing the provided resource unit to the AP over the provided resource unit.

2. The method of claim 1, wherein the resource unit is provided for a predefined duration, and the resource releasing frame is sent before the end of the predefined duration.

3. The method of claim 1, further comprising, at the peer station, sending, responsive to the reception of the triggering frame, a resource acknowledging frame for acknowledging the provided resource unit to the AP before starting performing the direct transmission with said another peer station.

4. The method of claim 1, further comprising receiving,
from the AP during the granted TxOP, one or more triggering frames triggering multi-user, MU, transmissions.

5. A communication method in a wireless network, comprising at an access point, AP, during a granted transmission opportunity, TxOP:
transmitting a triggering frame providing a resource unit for direct transmission to peer stations,
receiving, from one of the peer stations, a resource releasing frame for releasing the provided resource unit over the provided resource unit, and
responsive to the resource releasing frame, resuming transmission over the resource unit.

6. The method of claim 5, wherein the resource unit is provided for a predefined duration, and the resource releasing frame is received before the end of the predefined duration.

7. The method of claim 6, further comprising setting a network allocation vector, NAV, to defer a medium access by the AP to the end of the predefined duration.

8. The method of claim 7, further comprising, as the AP, receiving, in response to the reception of the triggering frame, a resource acknowledging frame from the peer station, wherein set the NAV is responsive to receiving the resource acknowledging frame.

9. The method of claim 5, further comprising transmitting during the granted TxOP, one or more triggering frames triggering multi-user, MU, transmissions.

10. The method of claim 1 wherein the resource releasing frame is a Single User, SU, data frame. SU frame format is defined in 802.11.

11. The method of claim 10, wherein the resource releasing frame is an 802.11 QoS Null frame.

12. The method of claim 10, wherein the resource releasing frame is an enhanced 802.11 QoS Null frame including a Buffer Status Report, BSR.

13. The method of claim 12, wherein the BSR includes DiL needs for the peer station.

14. The method of claim 10, wherein the resource releasing frame is a unicast 802.11 CF-End frame addressed to the AP.

15. A wireless communication device comprising at least one microprocessor configured for carrying out the steps of the method of claim 1.

16. A non-transitory computer-readable medium storing a program which, when executed by a microprocessor or computer system in a wireless device, causes the wireless device to perform the method of claim 1.
